(19) United States
(12) Patent Application Publication
(10) Pub. No.: US 2005/0117745 A1
(43) Pub. Date: Jun. 2, 2005

(54) Data encryption and decryption method using a public key

(75) Inventors: Kyung-hee Lee, Yongin-si (KR); Tae-chul Jung, Seongnam-si (KR); Evgeny Krouk, St. Petersburg (RU); Sergey Bezzateev, St. Petersburg (RU); Alexey Fomin, St. Petersburg (RU)

Correspondence Address: LEE & STERBA, P.C., Suite 2000, 1101 Wilson Boulevard, Arlington, VA, 22209, US

(73) Assignee: Samsung Electronics Co. Ltd.

(21) Appl. No.: 10/960,630

(22) Filed: Oct. 8, 2004

(30) Foreign Application Priority Data
Oct. 8, 2003 (KR) 2003-70027

(51) Int. Cl. H04L 9/00

(52) U.S. Cl. 380/30

(57) ABSTRACT

A data encryption method using a public key includes encoding data into a first code using a first public key, selecting a predetermined error vector, encoding the selected error vector into a second code using a second public key, and generating a ciphertext by adding the first and second codes. A corresponding decryption method includes performing first decoding of the ciphertext using a first set of a plurality of secret keys, determining locations of errors in the result of the first decoding using a second set of the plurality of secret keys and declaring erasures to the locations, performing second decoding according to a predetermined decoding algorithm and correcting a predetermined number of errors and the declared erasures, and detecting data from a result of correcting the errors and erasures.

### BACKGROUND OF THE INVENTION

1. Field of the Invention

The present invention relates to a data encryption and decryption method using a public key. More particularly, the present invention relates to a method for encrypting and decrypting data using a public key based on an error correcting code.

2. Description of the Related Art

An encryption algorithm is applied to data at one end of a communication channel using a specially selected public key to transform the data into a ciphertext. This encryption allows the data to be transmitted safely through the communication channel, even when the communication channel may not be secure. A decryption algorithm is used at the other end of the communication channel by a person having a secret key corresponding to the public key used in the encryption algorithm, to restore the ciphertext to the original data.

The most widely known methods among the public key cryptosystems, include a Rivest-Shamir-Adelman (RSA) algorithm and an algorithm applied to elliptic curve cryptography. However, while these algorithms provide excellent data protection capabilities, they have very low speeds of encryption or decryption.

At present, encryption methods based on linear code decryption include a McEliece method and a Niederreiter method. These two encryption methods operate in a similar manner. The McEliece cryptosystem will now be explained.

In a McEliece cryptosystem, secret keys are formed using a permutation matrix F, a generator matrix G of (n,k,d) Goppa code (here, n denotes a length of a code, k denotes a dimension, d denotes a minimum distance), and a non-singular matrix M operating as a scrambler, and a public key matrix K, which is defined as K=MGF. Natural number t is a number of errors correctable by the Goppa code and satisfies the following equation (1):
t≦└(d−1)/2┘ (1)
where, └ ┘ is a round-up operator.

In a McEliece cryptosystem, the process for encrypting and decrypting data vector x is as shown in the flowchart of FIG. 1. According to the flowchart, in step 10, data x to be encrypted is encoded into a length of n bits using the public key matrix K, where z=xK. In step 11, an error vector e whose weight is t, i.e., an error vector e in which t ones are randomly distributed in a zero vector having a length of n, is selected. The code generated in step 10 and the error selected in step 11 are combined to form encrypted data y, where y=z+e=xK+e. In step 12, encrypted data y is transmitted. In a receiving end, the inverse matrix of the permutation matrix F included in K is multiplied in step 13. The result can be expressed by a vector as the following equation (2):
z′=yF⁻¹=xMGFF⁻¹+eF⁻¹ (2)

Then, in step 14, an error correction decoding algorithm is applied to vector z′, removing the error vector e′=eF⁻¹ and codeword xMG is obtained. The data x is detected from xMG in step 15 using the inverse matrices of the generator matrix G and the non-singular matrix M.

A number of cryptanalytic attacks against the McEliece cryptosystem have been developed. Main existing attacks against the McEliece cryptosystem rely on the fact that the weight, i.e., the number of non-zero elements, of the error vector is much smaller than the length n of the underlying Goppa code. However, in most general cases, no algorithms with only polynomial complexity for computing plaintext from ciphertext are known for the McEliece cryptosystem. Despite their exponential complexity, existing attack algorithms are rather efficient. Thus, in order to keep information secure using the McEliece cryptosystem, it is necessary to use extremely large parameters, resulting in huge public keys, e.g., of about half a megabit.

Accordingly, a method for encrypting and decrypting data capable reducing sizes of a public key and a secret key is needed.

### SUMMARY OF THE INVENTION

The present invention is therefore directed to a method for encrypting and decrypting data, which substantially overcomes one or more of the problems due to the limitations and disadvantages of the related art.

It is a feature of an embodiment of the present invention to provide a method for encrypting and decrypting data using a public key, while maintaining a predetermined level of encryption security.

It is another feature of an embodiment of the present invention to provide a method for encrypting and decrypting data that reduces sizes of a public key and a secret key.

It is still another feature of an embodiment of the present invention to provide a method for encrypting and decrypting data using a decryption algorithm capable of correcting errors included in a selected error vector, based on an error correcting code.

At least one of the above and other features and advantages of the present invention may be realized by providing a data encryption method including encoding data into a first code using a first public key, selecting a predetermined error vector, encoding the selected error vector into a second code using a second public key, and generating a ciphertext by adding the first and second codes.

At least one of the above and other features and advantages of the present invention may be realized by providing a decryption method for receiving and decrypting including performing first decoding of the ciphertext using a first set of a plurality of secret keys, determining locations of errors in the result of the first decoding using a second set of the plurality of secret keys and declaring erasures to the locations, performing second decoding according to a predetermined decoding algorithm and correcting a predetermined number of errors and the declared erasures, and detecting data from the result of correcting the errors and erasures. The ciphertext has been generated by encoding data into a first code using a first public key, selecting a predetermined error vector, encoding the selected error vector into a second code using a second public key, and adding the first and second codes.

At least one of the above and other features and advantages of the present invention may be realized by providing a data encryption and decryption method including encoding data into a first code using a first public key, selecting a predetermined error vector, encoding the selected error vector into a second code using a second public key, generating a ciphertext by adding the first and second codes, performing first decryption of the ciphertext using a first set of a plurality of secret keys, determining the location of an error in the result of the first decryption using a second set of the plurality of secret keys and declaring an erasure to the location, performing second decryption according to a predetermined decryption algorithm, correcting a predetermined number of errors and the declared erasure, and detecting data from the result of correcting the errors and erasure.

The first public key may be an encoded matrix generated by a product of a generator matrix of an error correcting code and a non-singular matrix. The error vector may be an arbitrary error vector selected from a custom error set. The error vector may have a weight less than or equal to a number of errors correctable by an error correcting code. The second public key may be generated by the following equation: (I+A) FV, where I is a unit matrix, A is a generator matrix of an anticode, F is a permutation matrix, and V is a non-singular matrix generating the first public key.

The plurality of secret keys may include a generator matrix of an error correction code forming the first public key, a non-singular matrix, a generator matrix of an anticode forming the second public key, and a permutation matrix. The erasures may be determined from the generator matrix of the anticode.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a flowchart illustrating a conventional data encryption and decryption method;

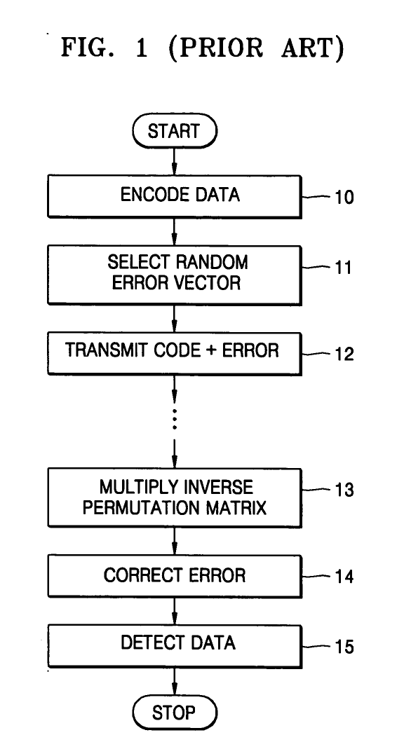

FIG. 2 is a flowchart illustrating a data encryption and decryption method according to an embodiment of the present invention;

FIG. 3 illustrates a comparative correctable error set for use with a decoding method using a lookup table; and

FIG. 4 illustrates a correctable error set for use with a decoding method using a lookup table in accordance with an embodiment of the present invention.

### DETAILED DESCRIPTION OF THE INVENTION

Korean Patent Application No. 2003-70027, filed on Oct. 8, 2003, in the Korean Intellectual Property Office, and entitled: “Data Encryption and Decryption Method Using a Public Key,” is incorporated herein by reference in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art.

The present invention generalizes the McEliece cryptosystem for data encryption and decryption. In accordance with an embodiment of the present invention, a code G is assumed to be defined by an encoding procedure Ω. Then, data x is encoded into a codeword c according to the encryption procedure. Assuming that Ψ denotes a decoding procedure, Ψ can correct an arbitrary error (e ⊂ E_{Ψ}) belonging to an error set selected by a user, i.e., customer error set (E_{Ψ}). The error correction procedure can be expressed as the following equation (3):
Ψ(y=a+e)=a (3)

In the encryption system according to an embodiment of the present invention, a public key is defined by the encoding procedure Ω and an error subset E_{Ψ}⁰ ⊂ E_{Ψ}. Also, a secret key is defined by a decoding procedure Ψ. The encryption procedure of the secret key is defined as y=Ω (x)+e (here, e ε E_{Ψ}⁰), and the decryption procedure is defined as x=Ψ (y).

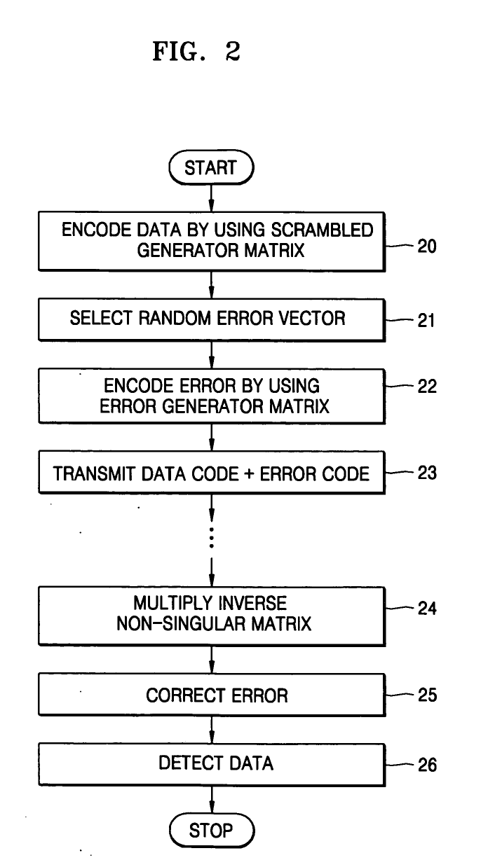

This procedure will now be explained in more detail with reference to the flowchart of FIG. 2. A public key according to an embodiment of the present invention includes two public keys, for example, a scrambled generator matrix K₁=GV and an error generator matrix K₂=(I+A)FV.

Here G is a generator matrix of an error correction code of (n,k,d), V denotes an n x n non-singular matrix, I is an n x n unit matrix, F is a permutation matrix, and A is an n x n generator matrix of an anticode. Here, anticode means a code in which the maximum weight of all codewords is not greater than a predetermined natural number m. Code length n should satisfy n>2t+m, where t is a number of errors correctable by an adopted error correction code, satisfying equation (1). The anticode generator matrix is formed by selecting an arbitrary matrix in which (n-m) columns have all zero elements. The secret keys, which an authorized user has, include G, V, F, and A.

The encryption and decryption process according to the present embodiment will now be explained. In step 20, data x to be encrypted is encoded using the scrambled generator matrix K₁ that is one of the public keys. In step 21, an error vector e whose weight is t is selected among custom error vectors. In step 22, the error vector selected in step 21 is encoded using an error generator matrix K₂ that is the other public key. Encrypted data y is expressed as the following equation (4) and is transmitted:
y=xK₁+eK₂, wt(e)≦t (4)

The receiving side multiplies encrypted data y by the inverse matrix of the non-singular matrix V that is one of the secret keys and obtains the result as the following equation (5) in step 24:
z=yV⁻¹=xG+e(I+A)F (5)

Since a holder of the secret keys knows the locations of non-zero elements in vector eA, the holder declares an erasure to each corresponding location in z, decodes z using a well-known error correction decoding algorithm and corrects t errors and m erasures to obtain the codeword c=xG in step 25. The data x is detected from the codeword c in step 26 using the generator matrix G.

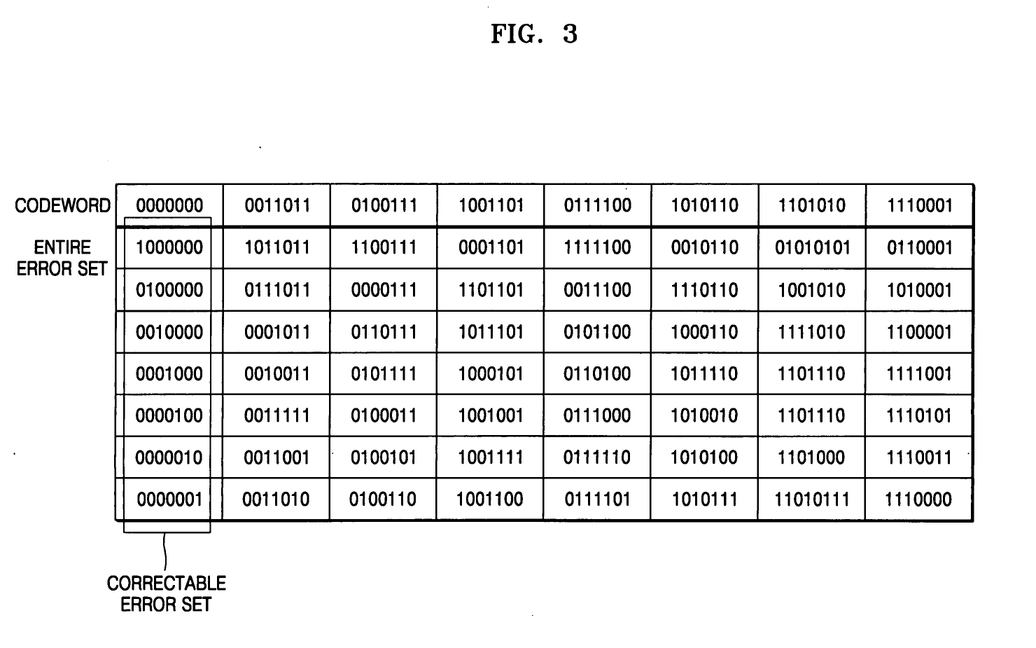

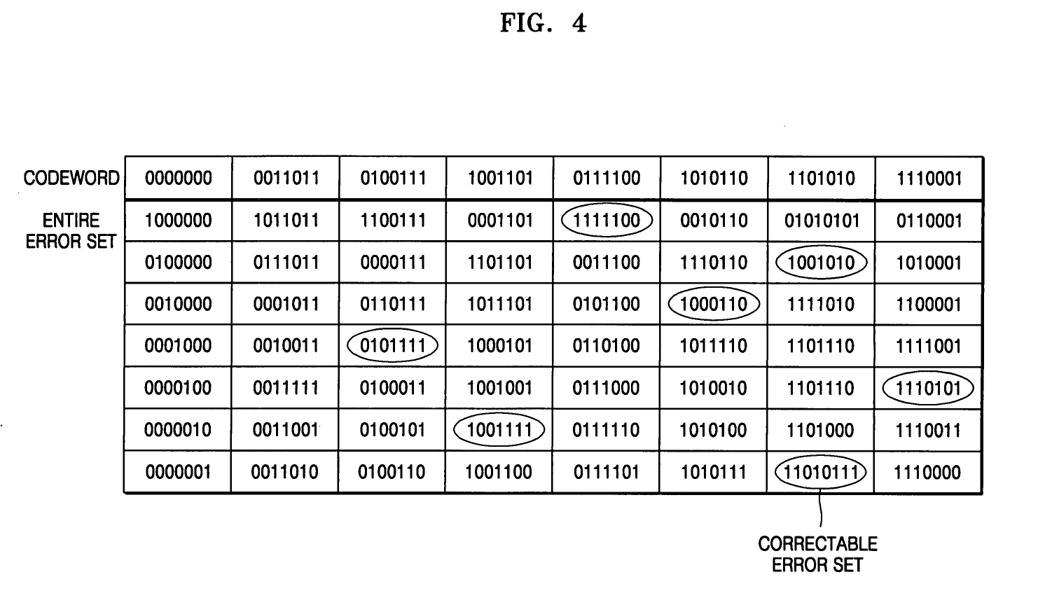

FIGS. 3 and 4 respectively illustrate correctable error sets according to a comparative example and an embodiment of the present invention to create a custom error set according to step 25 in FIG. 2.

The entire error set shown in FIGS. 3 and 4 is an error set that can be added to a codeword, and the correctable error set is an error set that can be corrected by decoding among the entire error set. FIG. 3 illustrates a standard correctable error set. FIG. 4 illustrates a correctable error set that is selected so that the decoding of the error set by an attacker becomes more difficult than the decoding of the standard correctable error set.

As can be seen in FIG. 4, the correctable error set according to an embodiment of the present invention is an actual error vector employed in the encryption procedure, i.e., e(I+A)FV. Therefore, the actual error vector has an arbitrary weight, which is much more difficult to determine without the secret key information. As a result, decryption attacks can be defeated.

According to the present invention, since a public key and a secret key are generated using an error correcting code, the complexity decreases compared to the conventional technology. In addition, by generalizing McEliece cryptosystem, error correcting code based encryption for a smaller sized public key can be performed. Also, since an error vector has an arbitrary weight, attacks from outside can be blocked.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A data encryption method, comprising:
encoding data into a first code using a first public key;
selecting a predetermined error vector;
encoding the selected error vector into a second code using a second public key; and
generating a ciphertext by adding the first and second codes.

2. The method as claimed in claim 1, wherein the first public key is an encoded matrix generated by a product of a generator matrix of an error correcting code and a non-singular matrix.

3. The method as claimed in claim 1, wherein the error vector is an arbitrary error vector selected from a custom error set.

4. The method as claimed in claim 3, wherein the error vector has a weight less than or equal to a number of errors correctable by an error correcting code.

5. The method as claimed in claim 1, wherein the second public key is generated by the following equation:
Second public key=(I+A) FV
where I is a unit matrix, A is a generator matrix of an anticode, F is a permutation matrix, and V is a non-singular matrix generating the first public key.

6. A decryption method for receiving and decrypting a ciphertext, the decryption method comprising:
performing first decoding of the ciphertext using a first set of a plurality of secret keys;
determining locations of errors in the result of the first decoding using a second set of the plurality of secret keys and declaring erasures to the locations;
performing second decoding according to a predetermined decoding algorithm and correcting a predetermined number of errors and the declared erasures; and
detecting data from a result of correcting the errors and erasures, wherein the ciphertext is generated by encoding data into a first code using a first public key, selecting a predetermined error vector, encoding the selected error vector into a second code using a second public key, and adding the first and second codes.

7. The method as claimed in claim 6, wherein the plurality of secret keys comprise a generator matrix of an error correction code forming the first public key, a non-singular matrix, a generator matrix of an anticode forming the second public key, and a permutation matrix.

8. The method as claimed in claim 7, wherein the erasures are determined from the generator matrix of the anticode.

9. A data encryption and decryption method, comprising:
encoding data into a first code using a first public key;
selecting a predetermined error vector;
encoding the selected error vector into a second code using a second public key;
generating a ciphertext by adding the first and second codes;
performing first decoding of the ciphertext using a first set of a plurality of secret keys;
determining locations of errors in the result of the first decoding using a second set of the plurality of secret keys and declaring erasures to the locations;
performing second decoding according to a predetermined decoding algorithm and correcting a predetermined number of errors and the declared erasures; and
detecting the data from the result of correcting the errors and erasures.

10. The method as claimed in 9, wherein the first public key is an encoded matrix generated by a product of a generator matrix of an error correcting code and a non-singular matrix.

11. The method as claimed in claim 9, wherein the error vector is an arbitrary error vector selected from a custom error set.

12. The method as claimed in claim 11, wherein the error vector has a weight less than or equal to a number of errors correctable by an error correcting code.

13. The method as claimed in claim 9, wherein the second public key is generated by the following equation:
Second public key=(I+A) FV
where I is a unit matrix, A is a generator matrix of an anticode, F is a permutation matrix, and V is a non-singular matrix generating the first public key.

14. The method as claimed in claim 9, wherein the plurality of secret keys comprise a generator matrix of an error correction code forming the first public key, a non-singular matrix, a generator matrix of an anticode forming the second public key, and a permutation matrix.

15. The method as claimed in claim 14, wherein the erasures are determined from the generator matrix of the anticode.
